(19) United States
(12) Patent Application Publication
(10) Pub. No.: US 2004/0086115 A1
(43) Pub. Date: May 6, 2004

(54) Image public key generation method

(75) Inventors: Chi-Sung Laih, Tainan (TW); Kun-Yuan Chen, Tainan (TW)

Correspondence Address: Jackson Walker L.L.P., Suite 2100, 112 E. Pecan Street, San Antonio, TX, 78205, US

(73) Assignee: Chi-Sung LAIH

(21) Appl. No.: 10/288,757

(22) Filed: Nov. 6, 2002

(51) Int. Cl. H04L 9/00

(52) U.S. Cl. 380/30

(57) ABSTRACT

A method for generating an image public key uses a predefined image as an input to the RSA algorithm to calculate a public key that includes the predefined image information. Translating the public key into an image generates an image public key. Therefore, the method allows a user to use a predefined image for identification and to generate a visible public key. That is, using the image public key easily identifies to whom the public key belongs so use of the wrong public key is less likely.

### BACKGROUND OF THE INVENTION

1. Field of the Invention

The present invention relates to an image public key generation method, and more particularly to a method that allows a user to use a predefined image as his visible public key to encrypt a message or verify a signature.

2. Description of Related Art

Public key cryptography is currently applied in our life to achieve privacy, authenticity, integrity and nonrepudiation in network communications. In the use of a public system, an original user “A” first generates his public/private key pairs and the other user(s) “B” can encrypt a message “M” to user A by using user A's public key. Furthermore, user B also can verify user A's signature “S” on the message M by using user A's public key.

Lastly, some public key cryptosystems such as DH, Elgamal, RSA, and ECC based on discrete logarithms in finite groups or integer factorization have been developed. Generally, the RSA public key cryptosystem is used by most people so many networks use the RSA public key cryptosystems for ID certification. The original RSA arithmetic block for generating public/private key pairs first has to randomly generate two prime numbers P and Q and each of them is about 512 bits. The public key has one integer N′ and one exponent e. The integer N′ is a product of two numbers P and Q. The exponent e is a common prime number between the integer N′ and the Euler phi-function φ(N′). Therefore, the generating public key is based on the random prime number so that the public key is not fixed. The private key only has one number d calculated by an Euclidean formula “e ×d=1 mod φ(N′)”.

Lenstra has proposed four methods for generating public/private key pair algorithms. With reference to FIG. 8, one of the Lenstra RSA algorithms has a new RSA arithmetic block with a predetermined leading number N. More details of the Lenstra algorithms are described in the original paper. The predetermined number N with half bits of the integer N′ can be determined by user A. Thus, the public/private key pairs calculated by Lenstra algorithms include the predetermined number N.

Furthermore, user A needs to apply for a certificate from a certificate authority (CA) to certify that the public key indeed belongs to user A. There are some standards to define the format of the Certificate such as X.509. For example, the RSA public key cryptosystem has adopted the X.509 version 3 setup in Windows™ OS, as shown in FIG. 9. The public key of the RSA public key cryptosystem has a long bit length of thousands of bits to improve the security consideration. Therefore, in the certificate, the long sequence of bits represent user A's public key. User B can use the public key to certify user A's message or verify user A's signature. When user B obtains the public key of user A, user B only sees a long serial number shown in Windows™ OS. When user B has many user's public keys and some of them have the same name of the CA, user B may hardly recognizing the public key is belong to. Consequently, user A cannot obtain the original message if the massage for user A has been encrypted with user C's public key. Thus, the identification of the public key is important.

An objective of the present invention is to provide an improved method for generating a visible RSA public key to mitigate and/or obviate the aforementioned problems.

### SUMMARY OF THE INVENTION

The main objective of the image public key generation method in accordance with the present invention is to provide an image public key. An image public key in the image of the person owning the public key makes identification of the image public key very easy.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a method for generating an image public key in accordance with the present invention;

FIG. 2 is a block diagram for using the image public key generated in FIG. 1;

FIG. 3 is a block diagram of a second embodiment of a method for generating an image public key in accordance with the present invention;

FIG. 4 is a block diagram for using the image public key generated in FIG. 3;

FIGS. 5A to D are operational flow charts of a simple example of FIG. 1;

FIGS. 6A to F are operational flow charts of a simple example of FIG. 2;

FIG. 7 is a frame of the Windows™ OS where the X.509 Certificate with the image public key is executed;

FIG. 8 is a block diagram of the Lenstra RSA algorithms, and

FIG. 9 is a frame of the Window™ OS where the X.509 Certificate with the image public key is executed.

### DETAILED DESCRIPTION OF THE PREFERRED EMBODIMENT

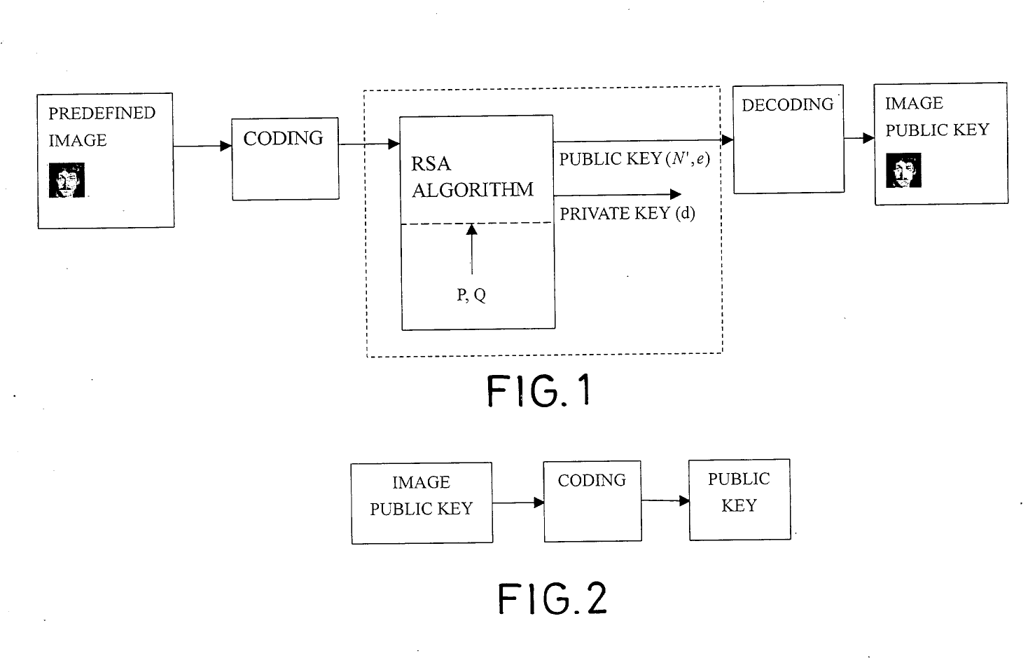

With reference to FIG. 1, a method for generating an image public key has the following steps:

1. preparing a predefined image that represents an user's identity such as a personal picture, a personal signet or a personal signature.

2. encoding the image by a specific encoding method to translate the predefined image to one-dimensional data. The predefined image is two-dimensional data so that the predefined image is encoded to transform it to one-dimensional data to be a first integer N.

3. calculating a public/private key pair (N′,e) and d. user A set of most significant bits (MSB) of one-dimensional data inputs and two random prime numbers P and Q are input into Lenstra RSA algorithm to calculate the public key including two elements, one second integer N′ and one exponent e and the private key d.

4. generating an image public key. The integer N′ is one-dimensional data, so that the decoded second integer N′ is transformed to two-dimensional data close to the predefined image that is the image public key.

Each image has unique one-dimensional data differs from the others, and two prime numbers are randomly generated, so the public key is unique. The public key owner can provide the image public key to people with whom the user would like to communicate. With reference to FIG. 2, people obtain the user image public key and then encrypt a message to the user by using user's public key. Using the image public key only translates the image public key to one-dimensional data, and then one-dimensional data further is encoded by a specific technique to be a useful public key. People can use the public key to encrypt a message and then send the message to the user.

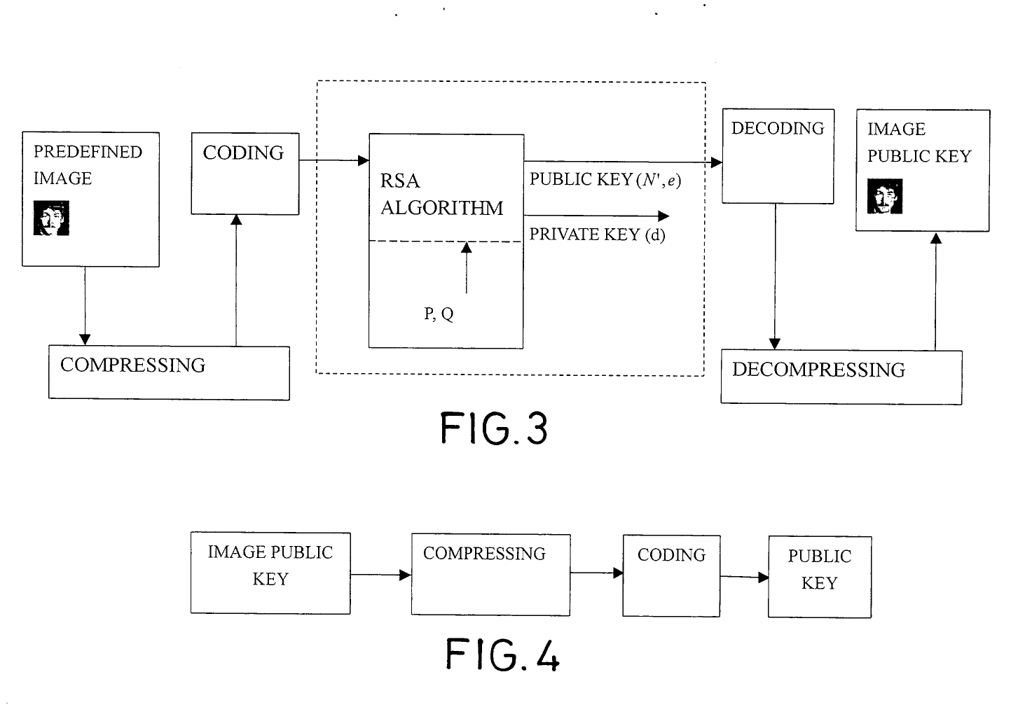

With reference to FIG. 3, another method for generating the image public key uses a large image to generate the public key. The method using a large predefined image with many bits basically has the same steps as the previously described method but comprises two additional steps, a compressing step and a decompressing step. The compressing step is added before the coding step, and the decompressing step is added following the decoding. The large predefined image first is compressed with an image compression technique, and then the compressed image is input to Lenstra RSA algorithm through the encoding step. Reciprocally, the decompressing step after the decoding step is used to restore an image that is close to the predefined image. Briefly, the method with the compressing/decompressing steps can use a large image to generate a large image public key. With reference to FIG. 4, when a person does not need the actual image to identify the owner of the image public key, the image public key can be generated through the compressing step, the encoding step and successfully used in that form.

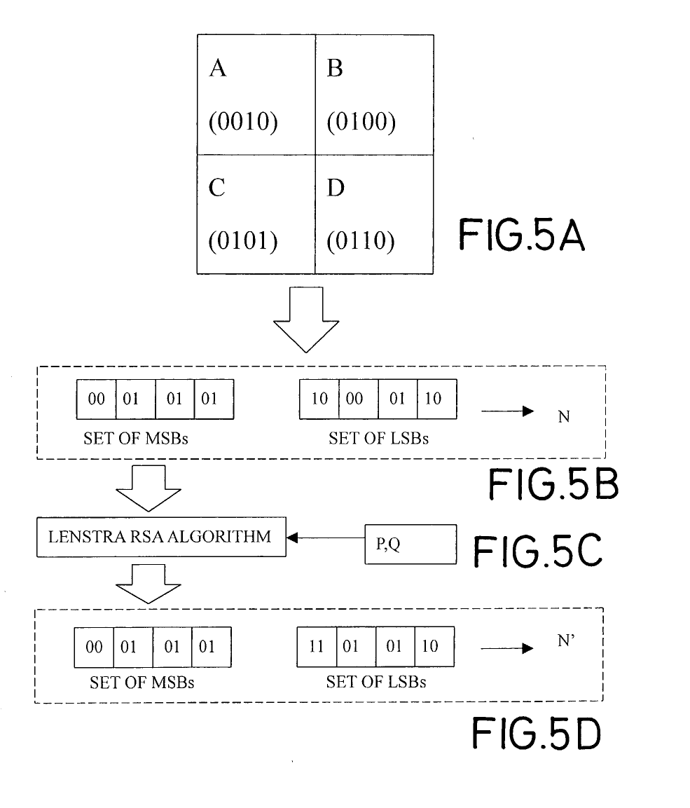

With reference to FIGS. 5A to 5D, for example, the method of the present invention is applied to a simple two-dimensional image. The image is composed of 2×2 pixels, which are respectively denoted with A, B, C, and D. The total bits of each pixel is represented by LSBs “i” and MSBs “j”. In this example, the LSBs has two bits (i=2) and the MBSs (j=2) has two bits, too. Therefore, the total bits “b” of each pixel, which is calculated by a formula “b=i+j”, is equal to four. Thus, the gray level of each pixel is 16.

Firstly, the two-dimensional image is converted to one-dimensional data by a special arrangement in the coding step, as shown in FIG. 5B. The special arrangement converts the image into a one-dimensional data that has many sets “t” of bits. Each set “t” is composed of eight bits.

To form the special arrangement, each pixel from A to D is extracted to a set of MSBs (denoted with t1 in FIG. 5B) and a set of LSBs (denoted with t2 in FIG. 5B), moreover, each of set has eight bits. Therefore, the image shown in FIG. 5A is converted into two sets, t1 and t2 as shown in FIG. 5B. That is, the total bits “s” of the image are calculated by a formula “s=b×t”, where “b” is the number of bit contained in each set, and “t” is the number of set.

With reference to FIGS. 5B to 5D, the one-dimensional data, which is deemed as a first integer N, is then calculated by Lenstra RSA algorithm. The calculated result is deemed as a second integer N′, which is a first element of the public key. The MSB set of the second integer N′ is the same as the MSB set of the first integer N. Only a portion of the LSB set of the integer N′ differs from the LSB set of the first integer N. Thus, when the second integer N′ is decoded by the function “T(N)” to an image public key, the image public key is still similar to the predefined image. The exponent e can be calculated by two kinds of Lenstra RSA algorithms (1) and (2) that can be used by the present method.

(1) Lenstra RSA algorithm with a common exponent e.

The exponent e is a common prime number between the second integer N′ and the Euler phi-function φ(N). Therefore, the exponent e and the image public key are provided to people who need to send encrypted communications to the public key owner.

(2) Lenstra RSA algorithm with a fixed exponent e.

The Lenstra RSA algorithm further comprises a reversible function “f( )” to generate the exponent e. The exponent e is calculated by a reversible formula “f(N)”, wherein “f⁻¹(e)” is a relationship between the first integer N and the second integer N′ so that the image public key is the same as the predefined image.

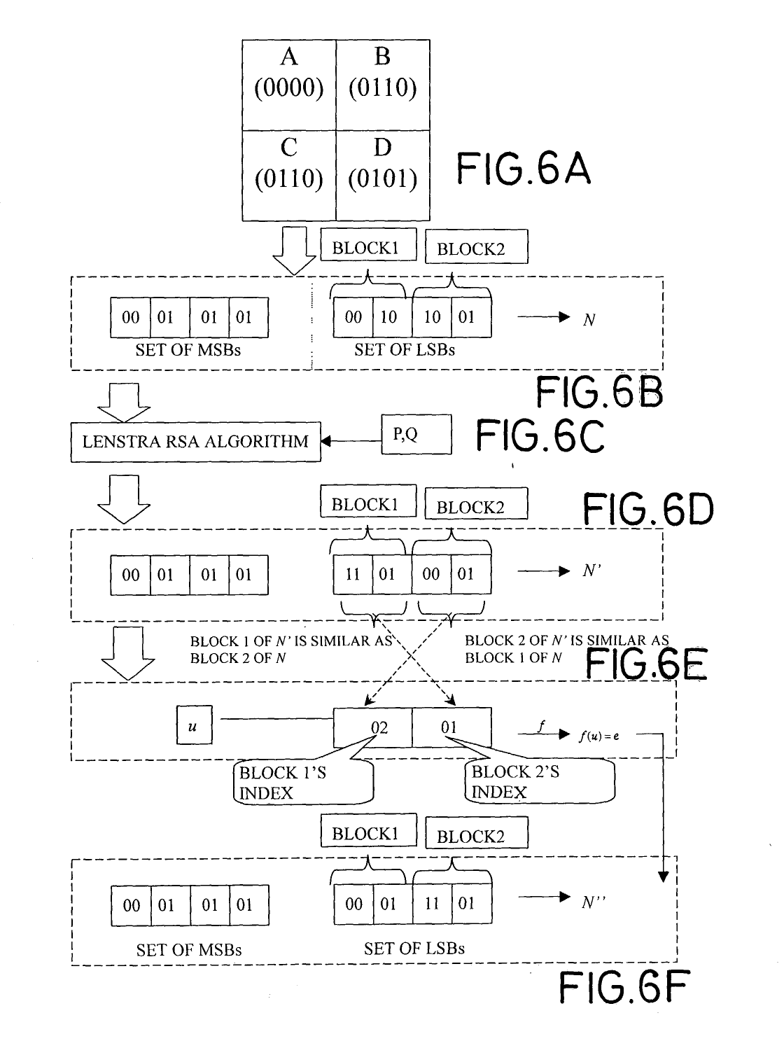

With reference to FIGS. 6A to 6F, data “u” is defined as “f⁻¹(e)”. Because the LSB set of the first integer N differs from the LSB set of the second integer N′, the image public key is a little bit of different from the predefined image. A new third integer N″, which is equal to the first integer N, is calculating by adding data “u” into the second integer N′. The exponent e is calculated by the formula “f(u)”. When a person who communicates with the image public key owner uses the image public key, the image public key is encoded to one-dimensional data as the third integer N″. The data “u” is calculated by the formula “f⁻¹(e)” and then the integer N′ is calculated together by the third integer N″ and the data “U”.

The user can give one predefined image that clearly identifies the user to people who need to communicate with the user in an encrypted mode. The predefined image can be used to generate an image public key. People can easily identify to whom the public key belongs so that they can manage lots of public keys without using the incorrect public key.

Details of combining the image public key with the X.509 Certificate is described in format of certificate that is defined as:

| TBSCertificate::= SEQUENCE{ | |
|---|---|
| Version [0] | EXPLICIT Version DEFAULT v1, |
| serialNumber | CertificateSerialNumber |
| signature | AlgorithmIdentifier, |
| issuer | Name, |
| validity | Validity, |
| subject | Name, |
| subjectPublicKeyInfo | SubjectPublicKeyInfo |
| } | |

The public key coded from the image public key is stored in the object “subjectPublicKeyInfo”. The “subjectPublicKeyInfo” defines as follows,

VisibleRSAPublicKeyInfo ::= SEQUENCE{

| | |
|---|---|
| Modulus | INTEGER,- - n |
| publicExponent | INTEGER- -e |
| } | |

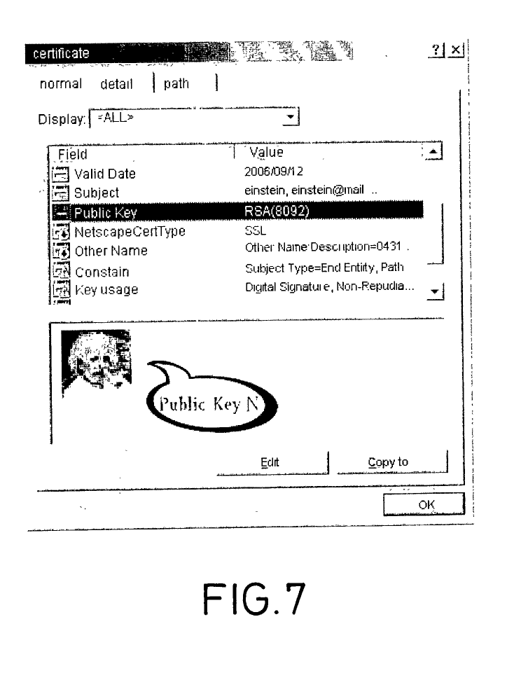

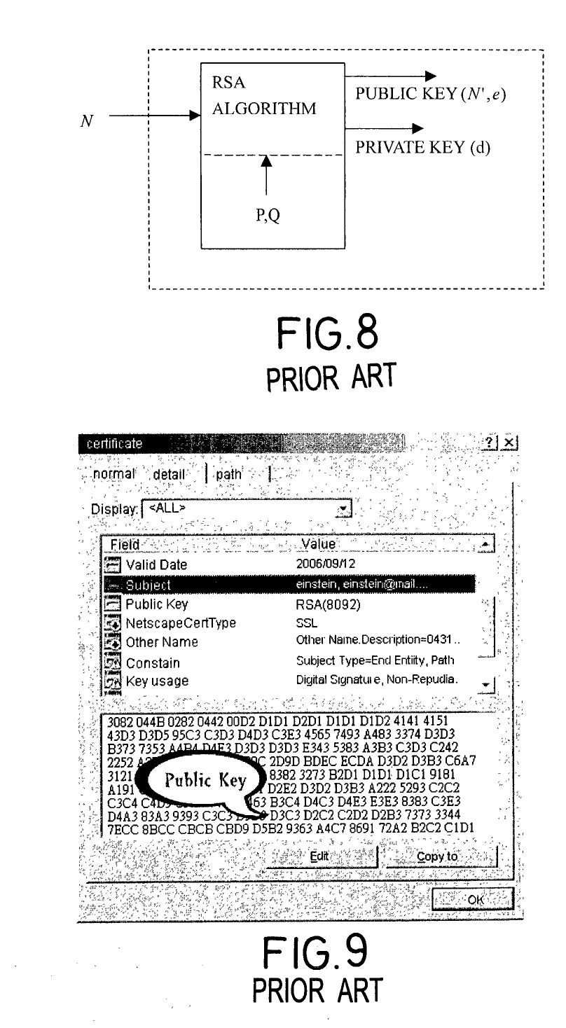

The image public key is stored in the object field and is shown on the X.509 Certificate in Windows™ OS. With reference to FIG. 7, the frame from the Windows™ OS shows the X.509 Certificate. Clicking the public key on the frame displays the image at the bottom of the frame. Therefore, the user can easily identify to whom the public key belongs by checking the image.

Even though numerous characteristics and advantages of the present invention have been set forth in the foregoing description, together with details of the structure and function of the invention, the disclosure is illustrative only, and changes may be made in detail. The details will expressed, especially in matters of shape, size, and arrangement of parts within the principles of the invention to the fill extent indicated by the broad general meaning of the terms in the appended claims.

What is claimed is:

1. An image public key generation method comprises the steps of:
preparing a predefined image that represents a user's identity, wherein the predefined image is two-dimensional data;
encoding the predefined image to transform the two-dimensional data to one-dimensional data to be used as an integer N input into an RSA algorithm;
calculating a public/private key pair, wherein two prime numbers randomly generated and the integer N are input to the RSA algorithm to calculate an integer N′ and an exponent e; and
decoding the public key to generate two-dimensional data to form an image public key, wherein the image public key is close to the predefined image; wherein using the two-dimensional data of the image public key further is encoded to a one-dimensional data as a public key.

2. The image public key generation method as claimed in claim 1, wherein the method further comprises a compressing step and a decompressing step, wherein the compressing step comes before encoding the predefined image step and compresses the predefined image and the decompressing step comes after the decoding the public key step and decompresses the public key one-dimensional data.

3. The image public key generation method as claimed in claim 1, wherein the exponent e is a common prime number between the integer N′ and a Euler phi-function φ(N′).

4. The image public key generation method as claimed in claim 1, wherein in the calculating a public/private key pair step, the exponent e is calculated by a reversible formula f(N′), wherein f⁻¹(e) is a relationship between the integer N and the integer N′ to make the image public key the same as the predefined image.

5. The image public key generation method as claimed in claim 2, the compressing step is image compression.

6. The image public key generation method as claimed in claim 1, wherein the predefined image is a personal picture.

7. The image public key generation method as claimed in claim 1, wherein the predefined image is a personal signature.

8. The image public key generation method as claimed in claim 1, wherein the predefined image is personal signet.

9. The image public key generation method as claimed in claim 1, wherein the integer N′ of the public key is calculated by the RSA algorithm, wherein the integer N′ is a product of two prim numbers P and Q generated randomly.
